(19) United States
(12) Patent Application Publication
(10) Pub. No.: US 2007/0124411 A1
(43) Pub. Date: May 31, 2007

(54) Centralized third party software and services upgrading and authorization

(76) Inventors: Shree A. Dandekar, Round Rock, TX (US); Shannon C. Boesch, Austin, TX (US)

Correspondence Address: HAMILTON & TERRILE, LLP, P.O. BOX 203518, AUSTIN, TX, 78720, US

(21) Appl. No.: 11/283,568

(22) Filed: Nov. 18, 2005

(51) Int. Cl. G06F 15/16

(52) U.S. Cl. 709/217

(57) ABSTRACT

A system for upgrading and authorizing a third party component loaded onto an information handling system which includes an upgrade and authorization module which enables a customer to indicate a desire to upgrade at least one upgradeable component wherein the upgrade and authorization module is executed by a system supplier, and a database which receives information from and supplies information to the upgrade and authorization module is disclosed.

### BACKGROUND OF THE INVENTION

1. Field of the Invention

The present invention relates to information handling systems, and more particularly, upgrading and authorizing third party software and services on the information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to order information handling systems either via the telephone or over the internet. It is also known to custom configure systems that are ordered via either method.

One issue relating to information handling systems that are custom configured relates to providing software or services with the custom configured information handling system. The software or services may be provided when software or services are ordered when the information handling system is ordered or via an additional opportunity to order the software or services after the system is received by a customer.

More specifically, when a custom configured information handling system is ordered, a customer is provided with an opportunity to order additional software or some form of a subscription service at the time of ordering the custom configured information handling system. Additionally, the custom configured information handling system is provided to the customer with an additional opportunity to order additional software or some form of subscription service. Certain software or subscription services may have limited time licenses (i.e., the software or subscription services are renewable components of the information handling system).

It is known to provide trial offers for software or services when an information handling system is shipped to a customer. For example, an information handling system might include a trial offer for one week of artist on demand radio from a MusicMatch music service, six free months of internet access from an internet service provider such as America Online (AOL) or 20 free photos from a photo printing service such as the Ofoto printing service.

Because many customers never use these trial offers, the trial offers may be provided to the information handling system provider at little or no cost. Customers who do not want to try the trial offer are not burdened with unwanted software royalties. Customers who do try services and decide to upgrade their trial offers are then required to arrange a billing relationship with the third party supplier of the software or service. In some cases, suppliers may require that the customer arrange a billing relationship prior to enabling the trial offer to reduce the likelihood of fraud or customers mistakenly signing up for multiple trial offers.

However, known methods of upgrading or authorizing trial offers can present challenges to the information handling system provider. For example, a customer's desire to upgrade to a new service may require multiple billing relationships to be established with different third party suppliers to enable the purchase or additional features and capability. This upgrade or authorization often occurs after the point of sale of the information handling system. In some cases simply enabling the trial offers that are preloaded on the new information handling system may require multiple billing relationships to be established. These challenges are amplified when the number of trial offers that are preloaded onto the information handling system increases.

Because the manufacturer often receives revenue for the transition from a trial offer to an upgrade, it is desirable for the manufacturer to be able to provide the opportunity for the customer upgrade or authorize the transition without the need for the customer to access multiple third party suppliers.

### SUMMARY OF THE INVENTION

In accordance with the present invention, a process for centralizing the upgrading and authorization of third party software and services by an information handling system supplier is described. The process funnels after point of sale billing relationships through an information handling system supplier.

The process provides an enhanced customer experience as customers are able to purchase additional services much faster after an initial purchase from the supplier. The process also increases after point of sale up-sells to customers that are more comfortable providing sensitive information to an information handling system provider than a number of third party suppliers.

More specifically, the process includes providing a process that allows customers to upgrade or authorize third party software or services via a configurator. The configurator provides a selection next to appropriate software and service categories that grants the manufacturer permission to recharge an account such as a credit card account than a predefined term commitment expires. The manufacturer then communicates the renewal to the customer and updates appropriate internal systems and partner systems to reflect the changed status. The system can also include an option for renewal when an original account is no longer valid.

In one embodiment, the invention relates to a system for upgrading and authorizing a third party component loaded onto an information handling system which includes an upgrade and authorization module which enables a customer to indicate a desire to upgrade at least one upgradeable component wherein the upgrade and authorization module is executed by a system supplier, and a database which receives information from and supplies information to the upgrade and authorization module.

In another embodiment, the invention relates to a method for upgrading and authorizing a third party component loaded onto an information handling system which includes enabling a customer to indicate a desire to upgrade at least one upgradeable component via a system supplier, receiving an indication from the customer regarding the desire to upgrade the at least one upgradeable component, and supplying information to a supplier of the third party component to indicate the desire to upgrade the at least one upgradeable component.

In another embodiment, the invention relates to an apparatus for upgrading and authorizing a third party component loaded onto an information handling system which includes means for enabling a customer to indicate a desire to upgrade at least one upgradeable component via a system supplier, means for receiving an indication from the customer regarding the desire to upgrade the at least one upgradeable component, and means for supplying information to a supplier of the third party component to indicate the desire to upgrade the at least one upgradeable component.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of access to a system configuration store.

FIG. 2 shows a system block diagram of an information handling system.

FIG. 3 shows a schematic block diagram of the operation of the system configuration store

FIG. 4 shows a schematic block diagram of the system configuration store.

FIG. 5 shows a flow diagram of operation of a system for centralized third party software and services upgrading and authorization.

FIG. 6 shows an example screen presentation of a upgrading and authorization module.

### DETAILED DESCRIPTION

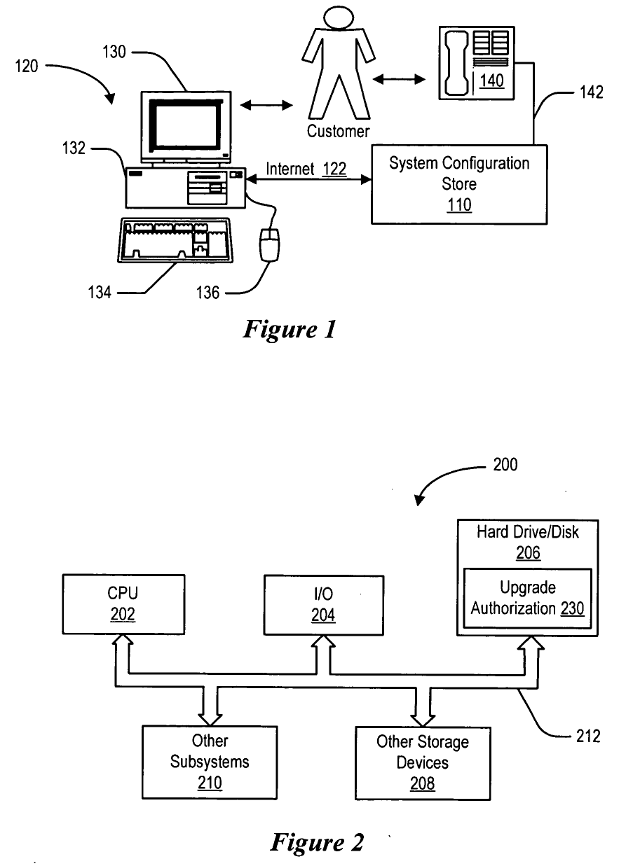

Referring to FIG. 1, a customer can access a system configuration store 110 using any suitable computer equipment 120, via the Internet 122. The computer equipment 120 may include a display 130, computer 132, keyboard 134, and pointing device 136. Display 130 is used for displaying the various pages of the online store while a customer is using the online store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system. The system configuration store 110 provides a central location for upgrading and authorizing third party software and services.

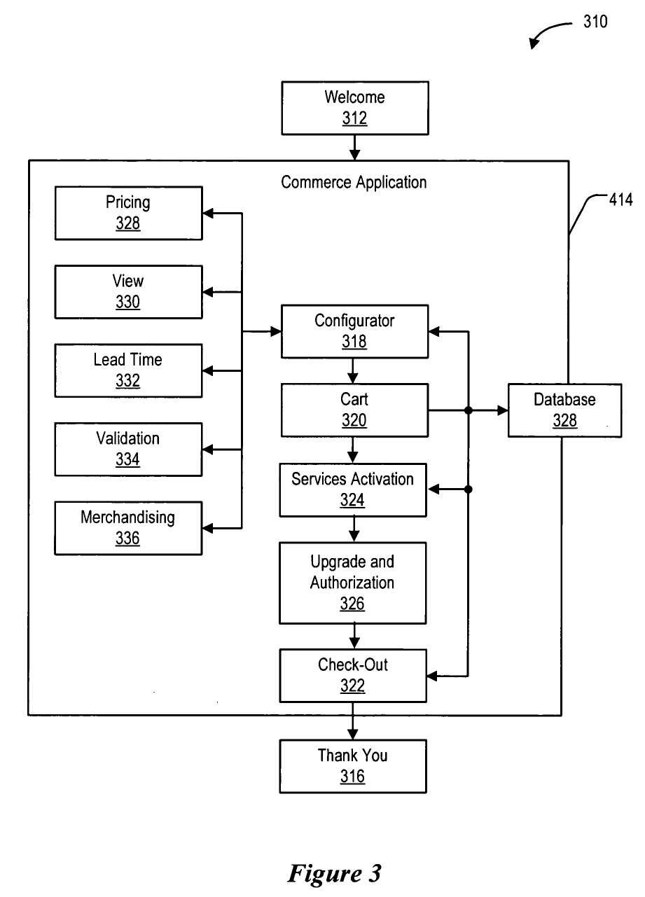

Referring to FIG. 2, a system block diagram of an information handling system 200 is shown having features thereof configured in accordance with the system configuration store 110 as discussed herein. The information handling system 200 includes a processor 202, input/output (I/O) devices, such as a display, a keyboard, a mouse, and associated controllers, collectively designed by a reference numeral 204, a non-volatile memory 206 such as a hard disk and drive, and other storage devices, such as a floppy disk and drive and other memory devices 208, and various other subsystems 210, all interconnected via one or more buses 212.

The information handling system 200 also includes an upgrade and authorization module 230 stored on the non-volatile memory.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

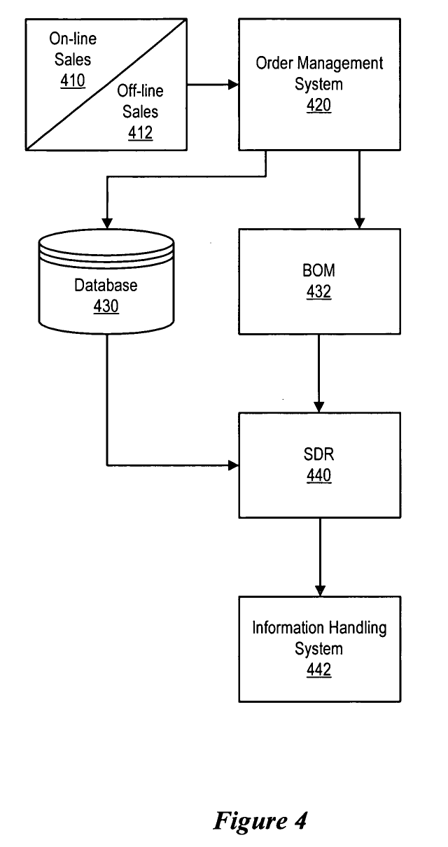

Referring to FIG. 3, an online store is a component of an Internet website to which a customer may go to configure a particular information handling system, for example, according to desired options of the customer as well as to upgrade or authorize software or services for an information handling system. An online store is one example of a system configuration store 110. The online store is typically a subset of a larger Internet website. At the online store, a customer can select one or more products in which the customer is interested. Upon selection of a particular product, the online store presents the customer with the ability to go to the product information for the particular product, customize the product, price the customized product, purchase the product, and other actions as discussed. While shopping happens in the website (i.e., selection of a particular kind of system by a customer), when the customer is ready to purchase a customized system, the customer is then directed to that part of the website which the online store application controls.

An online store 310 for use in generating customer configured information handling systems, e.g., customer configured computer systems, is shown. The online store 310 includes a welcome or introductory module 312, a commerce application module 314, and a thank you module 316. The online store 310 includes an online store user interface which enables the system configuration, pricing, and ordering of an information handling system via the Internet. The commerce application 314 includes a configurator 318, shopping cart 320, a checkout module 322, and a services activation module 324, an upgrade and authorization module 326 and database 328. The database 328 provides information to the configurator 318, shopping cart 320, checkout module 322, services activation module 324 and upgrade and authorization module 326. The configurator 318 includes a pricing module 328, a view module 330, a lead time warning module 332, a validation (or compatibility) warning module 334, and a merchandising module 336. The various modules of the configurator 318 are driven by data from the database 328, and thus the configurator 318, shopping cart 320, checkout module 322, services activation module 324 and upgrade and authorization module 326 are all linked to the database 328.

In operation of the online store 310, the welcome module 312 presents a welcome page 312, the configurator 318 presents a configurator page, the shopping cart 320 presents a shopping cart page, the checkout module 322 presents a checkout page, the services activation module 324 presents a services activation page, the upgrade and authorization module 326 provides an upgrade and authorization page and the thank you module 316 presents a thank you page. The welcome page includes a static page and generally resides outside of the commerce application 314. The configurator page, shopping cart page, checkout page, services activation page and upgrade and authorization page are within the commerce application and use information provided by the database. The checkout includes a payment feature, delivery feature, personal versus business feature, and instructional text features (i.e., how to fill out an online form.)

The welcome page is typically an introductory page and includes a link into the online store 310. The welcome page is typically a static welcome page. Upon completion of configuration of a system, is transferred to a services activation page in which the customer is provided an opportunity to activate various services such as internet service or content services such as music services. After completion of the services activation, the customer is transferred to the upgrade and authorization page. Alternately, if a customer is returning to the online store after receiving a configured information handling system, the customer may be transferred directly to the upgrade and authorization page. After completion of the upgrade and authorization, the customer is transferred to a checkout page. After completion of the checkout, the customer is transferred to a static thank you page. The thank you page provides a message of gratitude to the customer for having placed the order or for visiting the online store.

Aspects of the configurator 318 which interact with database 328 are shown in FIG. 3. In essence, the entire commerce application 314 interacts with the database. The configurator 318, shopping cart 320, checkout module 322, services activation module 324 and upgrade and authorization module 326 are each part of the commerce application 314 and interact with the database 328. For example, with the shopping cart 320, additional merchandising information associated with a particular system which has been configured and placed in the shopping cart by an online store customer can be provided.

Also, various services may be provided for order by the customer by the services activation module 324 based upon the type of system ordered as well as components that are included within the system ordered. Additionally, by providing the services activation module 326 and the upgrade and authorization module 236 within the commerce application 314, the customer continues the experience a similar customer experience and the system provider is able to use the information from the database 328 and to maintain control over the customer contact. By maintaining control over the customer contact the system provider is able to determine what services are activated and upgraded and to maintain accurate and up to date records of the service activation and upgrades.

When a purchase is processed via the telephone, then the customer representative interacts with a system similar to configurator 318.

The upgrade and authorization module 326 mitigates the need for customers to sign up with multiple suppliers when upgrading or ordering services. The upgrade and authorization module 326 enables a system supplier to funnel after point of sale billing relationships through the supplier. Rather than a customer being directed to each individual supplier billing site, customers are directed to the system supplier's online store site where the customers are provided with the option of adding to a new purchase to their existing supplier account, paying for the purchase with a supplier credit card or setting up a billing relationship with the supplier when upgrading or authorizing services. Thus, the process used, encourages fewer billing relationships for the customers who upgrade multiple products and services after point of sale. The process also provides an enhanced customer experience as customers are able to purchase additional services much faster after an initial purchase request is directed through the supplier. The process also increases after point of sale up-sells to customers that are more comfortable giving their billing information to the system supplier than to lesser known suppliers.

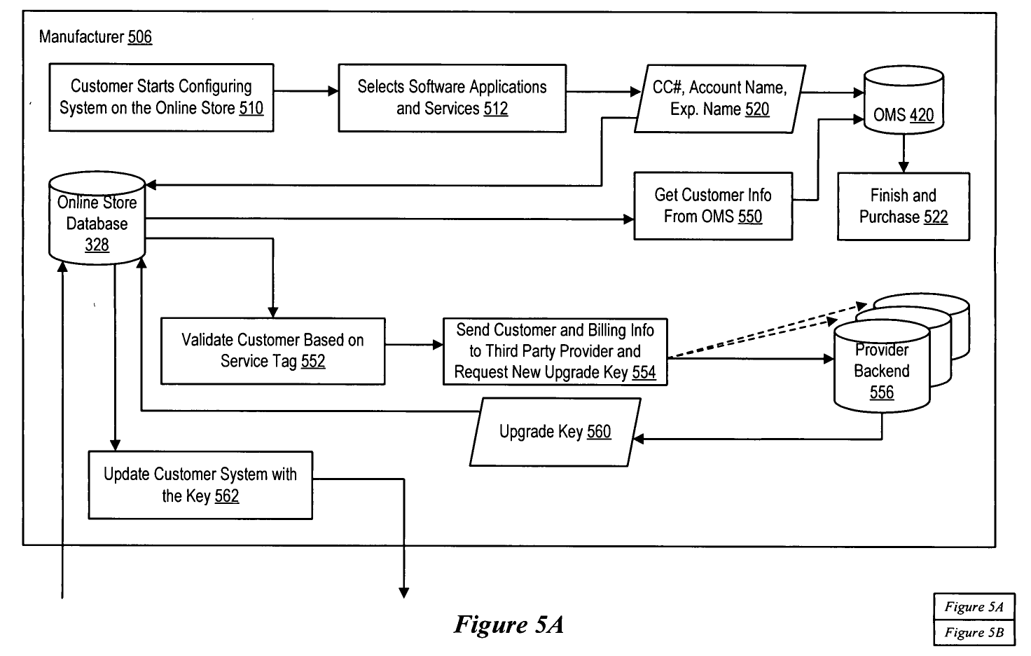

Referring to FIG. 4, when upgrade or authorization information is obtained either via online sales 410 or via off-line (e.g., telephone) sales 412, the information is provided to an order management system 420 which interacts with the factory in which the system is manufactured. The order management system 420 stores this information to a database 430 as well as to a Bill of Materials (BOM) 432 which is associated with a particular system being manufactured. It will be appreciated that one or both the database 430 or the BOM 432 may be used to associate the information from the customer order to a particular information handling system. The information is then stored in a system descriptor record (SDR) which is stored on the memory of the information handling system 442 either when the system is manufactured or after the upgrade and authorization information is obtained. Accordingly, the upgrade and authorization information that is obtained from the customer is stored on the system that is manufactured for that customer.

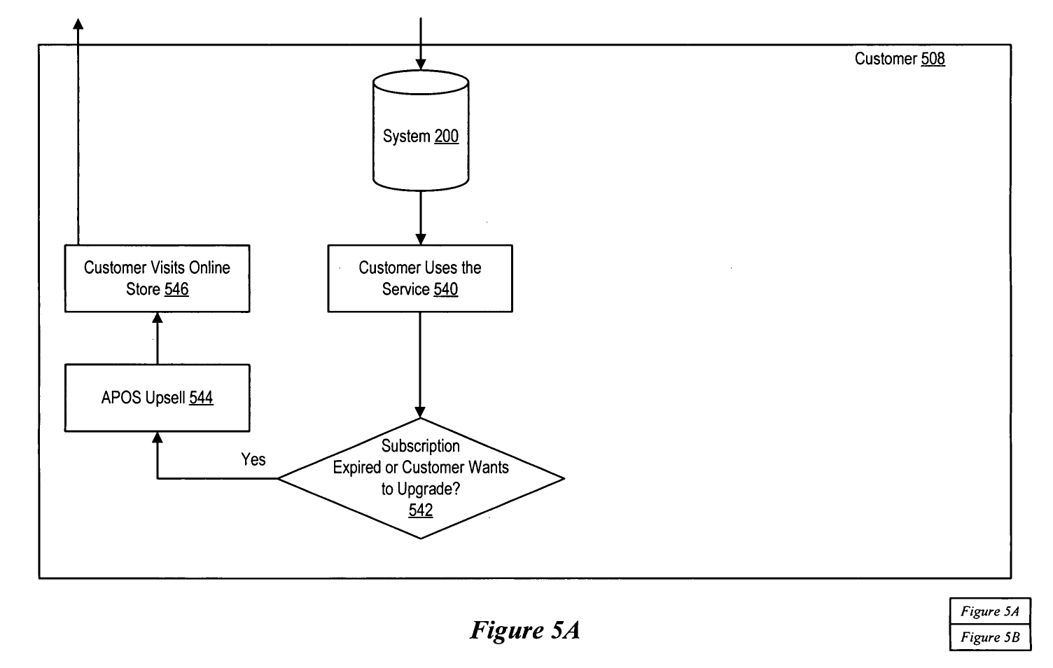

Referring to FIG. 5, a flow diagram of the operation of a system 500 for centralized third party software and services upgrading and authorization is shown. The system 500 includes a manufacturer portion 506 and a customer portion 508. More specifically, the order portion 506 of the system 500 starts when a customer starts configuring an information handling system either via the system configuration store 110 at step 510. Next, the customer selects particular software or service subscriptions at step 512 (e.g., via services activation module 324). The particular software or service subscriptions may be multiple software or service subscriptions from multiple vendors.

The customer then enters the relevant account information at step 520. For example, the account information can include a credit card number, name associated with the credit card and expiration date of the credit card. The credit card may be a system supplier credit card, in which case, the system supplier also derives revenue from the financing of either the system itself or any upgrades or authorizations that are purchased by the customer. The relevant information is then provided to the order management system 420 and the system is purchased at step 522. Relevant information is also provided to the online store database 328. This relevant information can include the credit card information as well as a service tag for the ordered information handling system.

When a customer receives the system and executes a particular software or service at step 540, then the upgrade and authorization module 230 stored on the system 200 determines whether an introductory subscription period has expired or whether the customer desires to upgrade the software or service at step 542. When the customer indicates a desire to upgrade or obtain authorization for a particular software or service, then an after point of sale up-sell occurs at step 544 and the upgrade and authorization module 230 automatically causes the customer to access the online store at step 546.

When the online store is accessed, then the database of the store 328 determines the service tag of the customer system and obtains customer information from the order management system 420 at step 550. The online store then validates the customer system based upon the system service tag at step 552. Next, at step 554, the system 500 provides customer and billing information to the third party software supplier or service provider 554 and requests any required upgrade keys to upgrade or authorize the software or service. The third party supplier then provides the upgrade key to the system supplier at step 560. The system supplier then updates the customer system with the key at step 562.

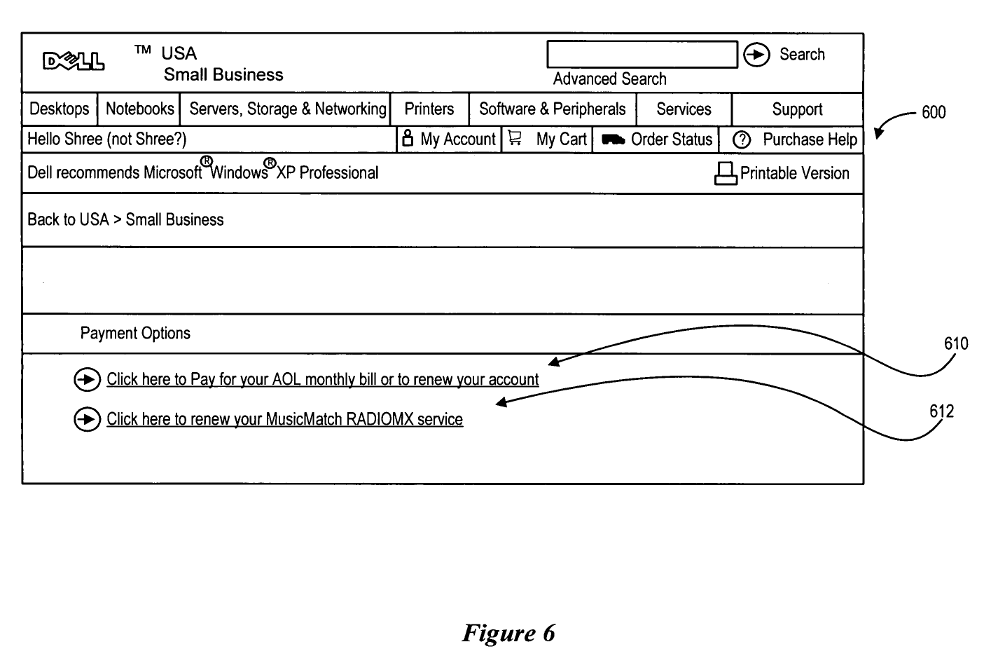

FIG. 6 shows an example screen presentation of an upgrade and authorization page 600. More specifically, when the upgrade and authorization page is accessed within the online store, the online store determines which upgrade or authorization information to present based upon the software and services that are associated with the particular information handling system. For example, if the information handling system has an associated internet service provider offer and a music service, then the upgrade and authorization page 600 presents the customer with the option of paying for an internet service provider 610 as well as renewing a music service 612.

### Other Embodiments

Other embodiments are within the following claims.

For example, it will be appreciated that the order in which the customer is presented with the services activation page, the upgrade and authorization page and check out page may vary. E.g., the customer may checkout before accessing the services activation page. Alternately, the services activation module and the upgrade and authorization page may be presented as a combined page.

Also for example, it will be appreciated that the upgrade and authorization module may be provided as a subset of another module's functions, such as the merchandizing module 336. Thus customers can select which software for upgrade and authorization as they are selecting individual software applications or upon checkout after an information handling system has been configured including all software that is to be loaded onto the information handling system.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for upgrading and authorizing a third party component loaded onto an information handling system comprising:
an upgrade and authorization module, the upgrade and authorization module enabling a customer to indicate a desire to upgrade at least one upgradeable component, the upgrade and authorization module being executed by a system supplier; and,
a database, the database receiving information from and supplying information to the upgrade and authorization module.

2. The system of claim 1 wherein:
information relating to the upgradeable component is pre-loaded onto the information handling system when the information handling system is fabricated.

3. The system of claim 1 further comprising
a service activation module, the service activation module enabling a user to activate services based upon the options selected according to user input, the activated services having an option for automatic authorization.

4. The system of claim 1 wherein:
the upgradeable component is a software application.

5. The system of claim 1 wherein:
the upgradeable component is a subscription service.

6. A method for upgrading and authorizing a third party component loaded onto an information handling system comprising:
enabling a customer to indicate a desire to upgrade at least one upgradeable component, the enabling being via a system supplier; and,
receiving an indication from the customer regarding the desire to upgrade the at least one upgradeable component; and,
supplying information to a supplier of the third party component to indicate the desire to upgrade the at least one upgradeable component.

7. The method of claim 6 wherein:
information relating to the upgradeable component is pre-loaded onto the information handling system when the information handling system is fabricated.

8. The method of claim 6 further comprising
enabling a user to activate services based upon the options selected according to user input, the activated services having an option for automatic authorization.

9. The method of claim 6 wherein:
the upgradeable component is a software application.

10. The method of claim 6 wherein:
the upgradeable component is a subscription service.

11. An apparatus for upgrading and authorizing a third party component loaded onto an information handling system comprising:
means for enabling a customer to indicate a desire to upgrade at least one upgradeable component, the enabling being via a system supplier; and,
means for receiving an indication from the customer regarding the desire to upgrade the at least one upgradeable component; and,
means for supplying information to a supplier of the third party component to indicate the desire to upgrade the at least one upgradeable component.

12. The apparatus of claim 11 wherein:
information relating to the upgradeable component is pre-loaded onto the information handling system when the information handling system is fabricated.

13. The apparatus of claim 11 further comprising
enabling a user to activate services based upon the options selected according to user input, the activated services having an option for automatic authorization.

14. The apparatus of claim 11 wherein:
the upgradeable component is a software application.

15. The apparatus of claim 11 wherein:
the upgradeable component is a subscription service.
